(19) United States
(12) Patent Application Publication
(10) Pub. No.: US 2007/0191531 A1
(43) Pub. Date: Aug. 16, 2007

(54) Method for the production of aqueous styrol-butadiene polymer dispersions

(75) Inventors: Wolfgang Gaschler, Heidelberg (DE); Christoph Hamers, Ludwigshafen (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF AKTIENGESELLSCHAFT, LUDWIGSHAFEN (DE)

(21) Appl. No.: 11/572,198

(22) PCT Filed: Jul. 14, 2005
(86) PCT No.: PCT/EP05/07641

§ 371 Date: Jan. 16, 2007

(30) Foreign Application Priority Data
Jul. 20, 2004 (DE) 10 2004 035 075.2

(51) Int. Cl. C08F 2/16

(52) U.S. Cl. 524/458; 524/571

(57) ABSTRACT

Process for the preparation of an aqueous styrene/butadiene polymer dispersion by free radical aqueous emulsion polymerization of a monomer mixture M comprising

| | |
|---|---|
| from 30 to 80% by weight | of styrene, |
| from 20 to 70% by weight | of butadiene and |
| from 0 to 40% by weight | of at least one ethylenically unsaturated |
| | comonomer differing from styrene |
| | and butadiene, |

based in each case on the total amount of the monomer mixture I, by a monomer feed process in the presence of a noncopolymerizable hydroperoxide of the general formula R—O—O—H as a regulator, in which the monomer mixture M is fed to the polymerization vessel in the course of 4 hours.

The present invention relates to a process for the preparation of an aqueous styrene/butadiene polymer dispersion by free radical aqueous emulsion polymerization of a monomer mixture M comprising

| | |
|---|---|
| from 30 to 80% by weight | of styrene, |
| from 20 to 70% by weight | of butadiene and |
| from 0 to 40% by weight | of at least one ethylenically unsaturated |
| | comonomer differing from styrene |
| | and butadiene, |

based in each case on the total amount of the monomer mixture M, by a monomer feed process in the presence of a noncopolymerizable hydroperoxide of the general formula R—O—O—H as a regulator, where R may be hydrogen, C₁-C₁₈-alkyl, C₇-C₂₂-aralkyl or a saturated or unsaturated carbocyclic or heterocyclic ring having 3 to 18 carbon atoms, wherein the monomer mixture M is fed to the polymerization vessel in the course of 4 hours.

Aqueous styrene/butadiene polymer dispersions have a variety of uses, in particular as binders in coating compositions, such as emulsion paints and paper coating slips, in barrier coatings, as a backing coating for carpeting, as adhesive raw material in carpet adhesives, in construction adhesives, for modifying mortar, cement and asphalt, for strengthening nonwovens, in sealing compounds, in molded foam parts and as binders for leather finishing.

The preparation of these dispersions is effected as a rule by free radical aqueous emulsion polymerization of monomer mixtures comprising styrene and butadiene. In this process, chain transfer agents are frequently used in order to avoid excessive crosslinking of the polymers which can have adverse effects on the performance characteristics of the dispersion. Such substances regulate the molecular weight of the polymer chains forming and are therefore also referred to as regulators.

The prior art proposes a very wide range of substances as regulators. Of commercial importance here are compounds having thiol groups, in particular alkyl mercaptans, such as n- and tert-dodecyl mercaptan cf. e.g. Ullmanns Encyclopedia of Industrial Chemistry, 5th ed. on CD-ROM, Synthetic Rubber 2.1.2). However, these substances are disadvantageous in various aspects, for example, they are difficult to handle owing to their unpleasant odor both before and during the polymerization. Another disadvantage is their effect on the natural odor of the dispersions. This cannot be completely suppressed even by comprehensive deodorization measures.

In order to avoid the odor problem in the preparation and processing of aqueous polymer dispersions, in particular aqueous styrene/butadiene polymer dispersions, EP-A 1380597 discloses the use of peroxides, in particular organic hydroperoxides, as sulfur- and halogen-free regulators. However, the publication does not disclose how and in which time the monomers and the regulators are fed to the polymerization medium. In the abovementioned publication, there is also no indication at all regarding the solution of the problem of minimizing the residual monomers, in particular on an industrial scale.

High residual monomer contents occur in particular when the content of styrene in the monomer mixture to be polymerized is 40% by weight or more and become all the more serious at styrene contents of 45% by weight or more, in particular 50% by weight or more and especially 55% by weight or more, Although high contents of volatile components can be partly removed by subsequent physical deodorization, the effort, not least the time required, and hence the costs increase with increasing residual monomer content. Furthermore, minimizing the residual monomers by chemical deodorization is expensive and time-consuming. Chemical deodorization is understood by a person skilled in the art as meaning postpolymerization initiated by free radicals under forced polymerization conditions (cf. for example DE-A 44 35 423, DE-A 44 19 518, DE-A 44 35 422, DE-A 102 41 481 and literature cited there).

It was therefore the object of the present invention to provide a process for the preparation of aqueous styrene/butadiene polymer dispersions which have no troublesome mercaptan odor and a low residual monomer content, in particular a relatively low styrene content, which process can be readily carried out in particular on an industrial production scale.

Accordingly, the process defined at the outset was found.

The process according to the invention is carried out by a monomer feed process. This is understood as meaning that the main amount, usually at least 70% by weight, preferably at least 80% by weight and in particular at least 90% by weight or the total amount of the monomers to be polymerized altogether is fed to the polymerization reaction under polymerization conditions. The term polymerization conditions is understood by a person skilled in the art as meaning that the aqueous polymerization medium comprises an amount of initiator which is sufficient for initiating the polymerization reaction and has a temperature at which the initiator has a decomposition rate sufficient for initiating the polymerization. The relationships between temperature and decomposition rate are sufficiently well known to a person skilled in the art for the conventional polymerization initiators or can be determined in routine experiments.

The process according to the invention is particularly suitable for the preparation of aqueous styrene/butadiene polymer dispersions which are obtained by free radical aqueous emulsion polymerization of a monomer mixture M comprising from 30 to 80% by weight, frequently from 35 to 75% by weight and often from 40 to 70% by weight of styrene, from 20 to 70% by weight, frequently from 25 to 65% by weight and often from 30 to 60% by weight of butadiene and from 0 to 40% by weight, frequently from 2 to 30% by weight and often from 3 to 25% by weight of at least one ethylenically unsaturated comonomer differing from styrene and butadiene, based in each case on the total amount of the monomer mixture M.

At this point, it should be noted that, in the context of this document, butadiene is 1,3-butadiene and that the stated amounts of the monomers contained in the monomer mixture M are also intended to reflect the percentages of the monomers incorporated in the form of polymerized units in the corresponding styrene/butadiene polymer.

Regarding the at least one comonomer, there are in principle no restrictions at all in the process according to the invention. Rather, the type and amount of the at least one comonomer optionally used depend primarily on the desired use. Examples of suitable comonomers are:
monoethylenically unsaturated monomers having an acid group such as mono- and dicarboxylic acids having 3 to 10 carbon atoms, such as acrylic acid, methacrylic acid, crotonic acid, acrylamidoglycol acid, vinylacetic acid, maleic acid or itaconic acid, and the monoesters of maleic acid with C₁-C₄-alkanols, ethylenically unsaturated sulfonic acids, such as vinylsulfonic acid, allylsulfonic acid, styrenesulfonic acid or 2-acrylamidomethylpropanesulfonic acid, and ethylenically unsaturated phosphonic acids, e.g. vinylphosphonic acid, allylphosphonic acid, styrenephosphonic acid and 2-acrylamido-2-methylpropanephosphonic acid, and their water-soluble salts, for example their alkali metal salts, preferably acrylic acid and methacrylic acid. Such monomers may be contained in the monomer mixture M in an amount of up to 10% by weight, for example from 0.1 to 10% by weight, preferably from 0.1 to 4% by weight;
amides of monoethylenically unsaturated carboxylic acids, such as acrylamide and methacrylamide, and the N-(hydroxy-C₁-C₄-alkyl)amides, preferably the N-methylolamides of ethylenically unsaturated carboxylic acids, such as N-methylolacrylamide and N-methylolmethacrylamide. Such monomers may be contained in the monomer mixture M in an amount of up to 10% by weight, for example from 0.1 to 10% by weight, preferably from 0.1 to 4% by weight;
hydroxyalkyl esters of monoethylenically unsaturated carboxylic acids, in particular hydroxyethyl, hydroxypropyl and hydroxybutyl esters, e.g. 2-hydroxyethyl acrylate, 3-hydroxypropyl acrylate, 2-hydroxyethyl methacrylate and 3-hydroxypropyl methacrylate. Such monomers may be contained in the monomer mixture M in an amount of up to 10% by weight, for example from 0.1 to 10% by weight, preferably from 0.5 to 5% by weight;
ethylenically unsaturated nitriles having preferably 3 to 10 carbon atoms, such as acrylonitrile and methacrylonitrile. Such monomers may be contained in the monomer mixture M in an amount of up to 30% by weight, for example from 1 to 30% by weight, preferably from 5 to 20% by weight;
reactive monomers: the reactive monomers include those which have a reactive functionality suitable for crosslinking. In addition to the abovementioned ethylenically unsaturated carboxylic acids, their N-alkylolamides and hydroxyalkyl esters, these include monomers which have a carbonyl group or an epoxy group, for example N-diacetoneacrylamide, N-diacetonemethacrylamide, acetylacetoxyethyl acrylate and acetylacetoxyethyl methacrylate, glycidyl acrylate and glycidyl methacrylate. Such monomers may be contained in the monomer mixture M in an amount of up to 10% by weight, for example from 0.5 to 10% by weight,
and crosslinking monomers: the crosslinking monomers include those which have at least two nonconjugated ethylenically unsaturated bonds, for example the di- and triacrylates or di- and trimethacrylates of di- and trifunctional alcohols, such as, for example, ethylene glycol diacrylate, diethylene glycol diacrylate, triethylene glycol diacrylate, butanediol diacrylate, hexanediol diacrylate, trimethylolpropane triacrylate and tripropylene glycol diacrylate. Such monomers may be contained in the monomer mixture M in an amount of up to 2% by weight, preferably not more than 1% by weight, e.g. from 0.01 to 2% by weight, preferably from 0.01 to 1% by weight. In a preferred embodiment, the monomer mixture M comprises no crosslinking monomer.

Preferred comonomers are the monoethylenically unsaturated mono- and dicarboxylic acids having 3 to 10 carbon atoms, their amides, their hydroxy-C₂-C₄-alkyl esters, their N-(hydroxy-C₁-C₄-alkyl)amides and the abovementioned ethylenically unsaturated nitrites. Particularly preferred comonomers are the monoethylenically unsaturated mono- and dicarboxylic acids, in particular acrylic acid, methacrylic acid and itaconic acid.

In a particularly preferred embodiment of the process according to the invention, the monomer mixture 3 to be polymerized comprises

| | |
|---|---|
| from 50 to 70% by weight | of styrene, |
| from 29 to 49% by weight | of butadiene and |
| from 1 to 10% by weight | of at least one comonomer, preferably |
| | at least one ethylenically unsaturated mono- |
| | or dicarboxylic acid. |

In another preferred embodiment of this process, a part of the styrene, preferably from 5 to 20% by weight, based on the total amount of monomer M, is replaced by acrylonitrile and/or methacrylonitrile. In this preferred embodiment, the monomer mixture M to be polymerized comprises, for example,

| | |
|---|---|
| from 40 to 65% by weight | of styrene, |
| from 29 to 44% by weight | of butadiene, |
| from 5 to 25% by weight | of acrylonitrile and/or methacrylonitrile and |
| from 1 to 10% by weight | of an ethylenically unsaturated mono- or |
| | dicarboxylic acid. |

With regard to the use of the styrene/butadiene polymers prepared by the process according to the invention as binders in coating materials, in particular in paper coating slips, it has proven advantageous if the polymer resulting from the aqueous emulsion polymerization has a glass transition temperature in the range from −20 to 50° C. and preferably in the range from 0 to 30° C. Here, the glass transition temperature is considered to be the midpoint temperature, which can be determined according to ASTM 3418-82 by means of DSC.

The glass transition temperature can be controlled in a manner familiar to a person skilled in the art by means of the monomer mixture M used.

According to Fox (T. G. Fox, Bull. Am. Phys. Soc. (Ser. II) 1, 123 [1956] and Ullmanns Encyklopädie der Technischen Chemie, Weinheim (1980), pages 17, 18), a good approximation for the glass transition temperature of copolymers at high molar masses is

$$\frac{1}{{T}_{g}} = \frac{{X}^{1}}{{T}_{g}^{1}} + \frac{{X}^{2}}{{T}_{g}^{2}} + … \frac{{X}^{n}}{{T}_{g}^{n}}$$

where X¹, X², . . . , Xⁿ are the mass fractions 1, 2, . . . , n and T_{g}¹, T_{g}², . . . , T_{g}ⁿ are the glass transition temperatures of the polymers composed in each case only of one of the monomers 1, 2, . . . , n, in degrees Kelvin. The latter are known, for example, from Ullmann's Encyclopedia of Industrial Chemistry, VCH, Weinheim, Vol. A 21 (1992) page 169 or from J. Brandrup, E. H. Immergut, Polymer Handbook 3^{rd} ed., J. Wiley, New York 1989. Accordingly, polystyrene has a T_{g} of 380 K and polybutadiene a T_{g} of 171 K or 166 K

It is essential for the process that the free radical aqueous emulsion polymerization be effected in the presence of a noncopolymerizable hydroperoxide of the general formula R—O—O—H as a regulator where R may be hydrogen, C₁-C₁₈-alkyl, C₇-C₂₂-aralkyl or a saturated or unsaturated carbocyclic or heterocyclic ring having 3 to 18 carbon atoms, and the radical R may be optionally substituted.

The radical R may be straight-chain or branched and may also be substituted, for example by one or more substituents from the group consisting of halogens, hydroxyl, alkoxy, aryloxy, epoxy, carboxyl, ester, amido, nitrile and keto groups. Preferred radicals R are hydrogen and the isopropyl, tert-butyl and tert-pentyl radicals and 1,1-dimethylbutyl and 1,1-dimethylpentyl radicals, which may optionally also be substituted by an OH group. A preferred aralkyl radical is the cumyl radical. Preferred carbocyclic radicals are the menthol and the pinene radical.

Particularly preferably, at least one hydroperoxide is used as a regulator and is selected from the group consisting of hydrogen peroxide, tert-butyl hydroperoxide, cumyl hydroperoxide, diisopropylbenzene monohydroperoxide, tert-pentyl hydroperoxide, 1,1-dimethylbutyl hydroperoxide, 1,1-dimethylpropyl hydroperoxide, 1,1-dimethyl-3-hydroxybutyl hydroperoxide, 1,1,3,3-tetramethylbutyl hydroperoxide, p-menthyl hydroperoxide, pinanyl hydroperoxide, 1-methylcyclopentyl hydroperoxide, 2-hydroperoxy-2-methyltetrahydrofuran, 1-methoxycyclohexyl hydroperoxide, 1,3,4,5,6,7-hexahydro-4a(2H)-naphthalenyl hydroperoxide β-pinene hydroperoxide and 2,5-dihydro-2-methyl-2-furanyl hydroperoxide.

The noncopolymerizable hydroperoxides can be used as regulator in addition to a polymerization initiator (“initiator” for short) and simultaneously as a regulator and initiator.

In principle, all those compounds which are known to a person skilled in the art for the initiation of a free radical aqueous emulsion polymerization of butadiene and styrene in the temperature range from ≧0° C. to ≦130° C., frequently from ≧60° C. to ≦110° C. and often from ≧70° C. to ≦100° C. are suitable as initiators or redox initiator combinations. Preferred initiators are water-soluble. Examples of such initiators are the sodium, potassium or ammonium salts of peroxodisulfuric acid, hydrogen peroxide, tert-butyl peroxide, potassium peroxodiphosphate, tert-butyl peroxopivalate, cumyl hydroperoxide, diisopropylbenzene monohydroperoxide or azobisisobutyronitrile. Said initiators are used in general in an amount of from 0.01 to 10% by weight and preferably from 0.1 to 5% by weight, based in each case on the total amount of the monomer mixture M. Said initiators in combination with a reducing agent are used as redox initiators. Suitable reducing agents are sulfites and bisulfites of the alkali metals and of ammonium, for example sodium sulfite or sodium bisulfite, the derivatives of sulfoxylic acid, such as zinc or alkali metal formaldehyde sulfoxylates, for example sodium hydroxymethanesulfinate, and ascorbic acid. The amount of reducing agent is in general from 0.01 to 10% by weight and preferably from 0.1 to 5% by weight based in each case on the total amount of the monomer mixture M. In a preferred embodiment, no further initiators are added apart from the noncopolymerizable hydroperoxide.

The hydroperoxides used as regulators can be initially taken in total in the aqueous polymerization medium, metered in in the total amount or initially taken in proportions, frequently ≦30% by weight, ≦20% by weight or ≦10% by weight, based in each case on the total amount of hydroperoxide, and the remainder metered in. If the hydroperoxides are used only as regulators and in combination with an initiator, it is possible to adopt a procedure in which the hydroperoxide is initially taken in total or is metered in in total together with monomer or initiator or is initially taken partly, frequently and in an amount of ≦30% by weight, ≦20% by weight or ≦10% by weight, based in each case on the total amount of hydroperoxide, and the remainder metered in together with the monomer or initiator. In the process variants in which the hydroperoxide is metered in in total or partly, a preferably adopted procedure in the case of the amounts to be added is for the molar ratio of hydroperoxide to initiator to be from 0.2 to 1 and frequently from 0.3 to 0.9 or from 0.4 to 0.8 during the initiation and in the course of the polymerization.

If the hydroperoxides are used both as regulator and as initiator, one of the abovementioned reducing agents is additionally used for forming a redox initiator system. The hydroperoxide can be initially taken in total, metered in in the total amount or initially taken partly and the remainder metered in in the course of the polymerization. Abovementioned reducing agents can also be initially taken in total, metered in in the total amount or initially taken partly and the remainder metered in in the course of the polymerization. Advantageously, however, the total amount of the reducing agent is metered in in the course of the polymerization reaction. Particularly preferably, the hydroperoxide is initially taken or metered in amounts such that the molar ratio of hydroperoxide to reducing agent during initiation and in the course of the polymerization is from 1.2 to 20, in particular from 1.5 to 7.5.

The initiator can be used both as such and as a dispersion or solution in a suitable solvent. Suitable solvents are in principle all conventional solvents which are capable of dissolving the initiator. Water and water-miscible organic solvents, e.g. C₁-C₄-alcohols, or mixtures thereof with water are preferred. In particular, the initiator is used in the form of an aqueous solution. The end of the initiator addition preferably coincides with the end of the monomer addition or occurs at the latest 1 hour, in particular at the latest 0.5 hour, after the end of the monomer addition.

The polymerization temperature naturally depends on the decomposition characteristics of the polymerization initiator and is preferably at least 60° C., in particular at least 70° C., particularly preferably at least 80° C. and very particularly preferably at least 90° C. Usually, a polymerization temperature of 120° C. and preferably 110° C. is not exceeded in order to avoid complicated pressure-resistant apparatuses. However, with a suitable choice of the reaction vessel, temperatures above this can also be used. In the so-called cold procedure, i.e. with the use of redox initiator systems, it is also possible to effect polymerization at lower temperatures, for example from as low as 5° C. or 10° C.

The process according to the invention is particularly suitable for the preparation of aqueous styrene/butadiene polymer dispersions on an industrial scale, for the preparation of which a total amount of butadiene of ≧1000 kg, ≧5000 kg or ≧10 000 kg is used.

Furthermore, aqueous styrene/butadiene polymer dispersions having a low residual monomer content, in particular relatively low styrene content, are obtainable by the process according to the invention if the monomer mixture M is fed to the polymerization vessel within relatively short metering times, for example within 3.5 hours or within 3 hours.

As a rule, the process according to the invention is effected exclusively in the presence of the abovementioned hydroperoxides as polymerization regulators. However, small amounts of other compounds which are known to act as polymerization regulators may also be tolerated. These include, for example, the abovementioned compounds having a thiol group, for example alkyl mercaptans, and the compounds mentioned in EP-A 407 059 and DE-A 195 12 999. Their proportion is as a rule less than 0.1% by weight of the monomers to be polymerized and preferably does not exceed 50 parts by weight, preferably 20 or 10 parts by weight, based on 100 parts by weight of hydroperoxide used altogether.

In addition, it has proven advantageous for reducing the residual monomer content, in particular the residual styrene content, if the monomer mixture M is fed to the polymerization vessel in the form of the monomer feeds Mz1 and Mz2, the feed Mz1 comprising styrene, butadiene and, if appropriate, at least one comonomer and the feed Mz2 consisting exclusively of butadiene, feed Mz2 being fed in when ≧70% by weight of feed Mz1 have been fed to the polymerization vessel, for a period Tz2 of ≧1% of the total feed time Tz1 of the feed Mz1, and feed Mz2 consisting of ≦30% by weight of the total amount of butadiene,

Frequently, feed Mz2 is begun after ≧75% by weight or ≧80% by weight, often, however, ≦99% by weight, ≦95% by weight or ≦90% by weight of feed Mz1 have been fed to the polymerization vessel.

Feed Mz2 corresponds to ≦30% by weight, frequently ≦25% by weight or ≦20% by weight and often ≦15% by weight or ≦10% by weight and ≧0.1% by weight, frequently ≧0.5% by weight or ≧1% by weight and often ≧1.5% by weight or ≧5% by weight, of the total amount of butadiene. Advantageously, feed Mz2 corresponds to ≧0.5 to ≦20% by weight or ≧1 to ≦20% by weight of the total amount of butadiene.

The feed time Tz2 is frequently ≧2%, ≧5%, ≧7%, or ≧10% and ≦40%, ≦30%, ≦20% or ≦15% of the total feed time Tz1 of the feed Mz1. Often, the feed time Tz2 is from ≧5 to ≦40% or from ≧7 to ≦20% of the total feed time Tz1. The maximum total feed time Tz1 is ≦4 hours, ≦3.5 hours or ≦3 hours. Frequently, the total feed time Tz1 is, however, ≦95%, ≦90%, ≦85% or ≦80% of the abovementioned times.

Advantageously, the process according to the invention is effected in the manner such that feed Mz2 is begun when ≧80% by weight of feed Mz1 have been fed to the polymerization vessel, the period Tz2 is from ≧5 to ≦40% of the total feed time Tz1 of the feed Mz1, and the feed Mz2 consists of from ≧0.5 to ≦30% by weight of the total amount of butadiene.

What is important for the invention is that the feeds Mz1 and Mz2 at least partly overlap. Feed Mz2 can be ended before, after or together with the feed of Mz1, However, it is important that the last feed be ended within 4 hours, within 3.5 hours or within 3 hours. According to the invention, feed Mz1 is advantageously ended after feed Mz2.

According to the invention, the feeds Mz1 and Mz2 can be fed to the polymerization vessel continuously or batchwise, in constant, increasing or decreasing flow rates. It is also possible in principle for the composition of feed Mz1 to change in the claimed composition range, for example by a step or gradient procedure, in the course of feeding. Advantageously, feed Mz1 is fed to the polymerization vessel without a change in the composition, continuously with constant flow rate, and feed Mz2 is fed to the polymerization vessel continuously with constant flow rate.

According to the invention, the monomers forming the monomer mixture M or the corresponding monomer feeds Mz1 and Mz2 can be fed to the polymerization vessel via separate feeds. Of course, it is also possible to feed the monomers forming monomer mixture M or the corresponding monomer feeds Mz1 and Mz2 to the polymerization vessel via one feed, if the monomer feed is effected via one feed, it has proven advantageous continuously to mix the monomers forming the monomer mixture M or the corresponding monomer feeds Mz1 and Mz2 before introduction into the polymerization vessel. Static mixers are particularly suitable for this purpose.

If the monomer feed is effected via one feed, the monomer feed Mz1 is first fed to the polymerization vessel. At a chosen time when ≧70% by weight of feed Mz1 have already been fed to the polymerization vessel, the butadiene feed is then increased for the chosen period Tz2 so that the additional amount of butadiene Mz2 is fed to the polymerization vessel.

Of course, it is also possible to feed the monomer mixture M or the corresponding monomer feeds Mz1 and Mz2 to the polymerization vessel so that, when ≧70% by weight of styrene and butadiene and of the optionally used at least one comonomer have been fed to the polymerization vessel, the flow rates of styrene and of the optionally used at least one comonomer are reduced while keeping the butadiene flow rate constant.

The addition of the monomer mixture M can be effected both in the form of the monomers as such and in the form of an aqueous emulsion of the monomers, the latter procedure generally being preferred.

If the monomers are fed to the polymerization reaction in the form of an aqueous emulsion, the proportion of monomers is usually from 30 to 90% by weight, in particular from 40 to 80% by weight, of the total weight of the aqueous emulsion. In addition, the monomer emulsion comprises, as a rule, at least a part, preferably at least 70% by weight, in particular at least 80% by weight, or the total amount of the dispersants usually required for an emulsion polymerization.

In the process according to the invention, at least one dispersant which keeps both the monomer droplets and the polymer particles formed during polymerization dispersed in the aqueous phase and thus ensures the stability of the aqueous polymer dispersion produced is concomitantly used. Suitable dispersants are both protective colloids and emulsifiers.

Suitable protective colloids are, for example, polyvinyl alcohols, polyalkylene glycols, alkali metal salts of polyacrylic acids and polymethacrylic acids, cellulose, starch and gelatin derivatives or copolymers comprising acrylic acid, methacrylic acid, maleic anhydride, 2-acrylamido-2-methylpropanesulfonic acid and/or 4-styrenesulfonic acid, and the alkali metal salts thereof, and also N-vinylpyrrolidone, N-vinylcaprolactam, N-vinylcarbazole, 1-vinylimidazole, 2-vinylimidazole, 2-vinylpyridine, 4-vinylpyridine, acrylamide, methacrylamide, and homo- and copolymers comprising amino-carrying acrylates, methacrylates, acrylamides and/or methacrylamides. A detailed description of further suitable protective colloids is to be found in Houben-Weyl, Methoden der organischen Chemie, Volume XIV/1, Makromolekulare Stoffe, Georg-Thieme-Verlag, Stuttgart, 1961, pages 411 to 420.

Of course, mixtures of emulsifiers and/or protective colloids can also be used. Frequently, exclusively emulsifiers whose relative molecular weights, in contrast to protective colloids, are usually below 1500, are used as dispersants. They may be anionic, cationic or nonionic. When mixtures of surface-active substances are used, the individual components must of course be compatible with one another, which in case of doubt can be checked by means of a few preliminary experiments. In general, anionic emulsifiers are compatible with one another and with nonionic emulsifiers. The same also applies to cationic emulsifiers, whereas anionic and cationic emulsifiers are generally not compatible with one another. An overview of suitable emulsifiers is to be found in Houben-Weyl, Methoden der organischen Chemie, Volume XIV/1, Makromolekulare Stoffe, Georg-Thieme-Verlag, Stuttgart, 1961, pages 192 to 208.

Customary nonionic emulsifiers are, for example, ethoxylated mono-, di- and trialkylphenols (degree of ethoxylation: from 3 to 50, alkyl radical: C₄ to C₁₂) and ethoxylated fatty alcohols (degree of ethoxylation: from 3 to 80; alkyl radical: C₈ to C₃₆). Examples of these are the Lutensol® A grades (C₁₂C₁₄-fatty alcohol ethoxylates, degree of ethoxylation: from 3 to 8), Lutensol® AO grades (C₁₃C₁₅-oxo alcohol ethoxylates, degree of ethoxylation: from 3 to 30), Lutensol® AT grades (C₁₆C₁₈-fatty alcohol ethoxylates, degree of ethoxylation: from 11 to 80), Lutensol® ON grades (C₁₀-oxo alcohol ethoxylates, degree of ethoxylation: from 3 to 11) and the Lutensol® TO grades (C₁₃-oxo alcohol ethoxylates, degree of ethoxylation: from 3 to 20) from BASF AG.

Conventional anionic emulsifiers are, for example, alkali metal and ammonium salts of alkylsulfates (alkyl radical: C₈ to C₁₂), of sulfuric monoesters of ethoxylated alkanols (degree of ethoxylation: from 4 to 50, alkyl radical: C₁₂ to C₁₈) and of ethoxylated alkylphenols (degree of ethoxylation: from 3 to 50, alkyl radical: C₄ to C₁₂), of alkanesulfonic acids (alkyl radical: C₁₂ to C₁₈) and of alkylarylsulfonic acids (alkyl radical: C₉ to C₁₈).

Furthermore, compounds of the general formula I 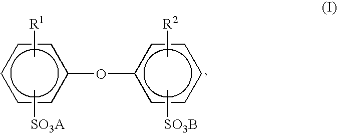
where R¹ and R² are hydrogen atoms or C₄- to C₂₄-alkyl and are not simultaneously hydrogen atoms, and A and B may be alkali metal ions and/or ammonium ions, have proven to be further anionic emulsifiers. in the general formula I, R¹ and R² are preferably linear or branched alkyl radicals having 6 to 18 carbon atoms, in particular having 6, 12 and 16 carbon atoms, or —H, R¹ and R² not both simultaneously being hydrogen atoms. A and B are preferably sodium, potassium or ammonium, sodium being particularly preferred. Compounds I in which A and B are sodium, R¹ is a branched alkyl radical having 12 carbon atoms and R² is a hydrogen atom or R¹ are particularly advantageous. Industrial mixtures which comprise from 50 to 90% by weight of the monoalkylated product, such as, for example, Dowfax® 2A1 (brand of Dow Chemical Company), are frequently used. The compounds I are generally known, for example from U.S. Pat. No. 4,269,749, and are commercially available.

Suitable cation-active emulsifiers are as a rule primary, secondary, tertiary or quaternary ammonium salts, alkanolammonium salts, pyridinium salts, imidazolinium salts, oxazolinium salts, morpholinium salts, and thiazolinium salts having a C₆- to C₁₈-alkyl or C₆- to C₁₈-aralkyl or a heterocyclic radical, and salts of amine oxides, quinolinium salts, isoquinolinium salts, tropylium salts, sulfonium salts and phosphonium salts. Dodecylammonium acetate and the corresponding hydrochloride, the chlorides or acetates of the various 2-(N,N,N-trimethylammonium)ethylparaffinic esters, N-cetylpyridinium chloride, N-laurylpyridinium sulfate and N-cetyl-N,N,N-trimethylammonium bromide, N-dodecyl-N,N,N-trimethylammonium bromide, N-octyl-N,N,N-trimethylammonium bromide, N,N-distearyl-N,N-dimethylammonium chloride and the Gemini surfactant N,N′-(lauryldimethyl)ethylenediamine dibromide may be mentioned by way of example. Numerous further examples are to be found in H. Stache, Tensid-Taschenbuch, Carl-Hanser-Verlag, Munich, Vienna, 1981 and in McCutcheon's, Emulsifiers & Detergents, MC Publishing Company, Glen Rock, 1989.

However, nonionic and/or anionic emulsifiers are particularly suitable.

As a rule, a total of from 0.05 to 20 parts by weight, frequently from 0.1 to 10 parts by weight and often from 0.2 to 7 parts by weight of dispersant, based in each case on 100 parts by weight of aqueous polymerization medium, formed from the total amounts of demineralized water and the at least one dispersant, are used.

The total amount of the dispersant can be initially taken in the reaction vessel before the beginning of the addition of the monomer mixture M. However, it is also possible initially to take only a portion of the dispersant in the reaction vessel before the beginning of the addition of the monomer mixture M and to add the remaining amount during the polymerization. If required, however, the total amount of the dispersant may also be added in the course of polymerization. Frequently, the total amount or at least the principle amount of the dispersant is fed to the polymerization vessel in the course of the polymerization, in particular in the form of an aqueous monomer emulsion.

Furthermore, it has proven advantageous if the reaction mixture is subjected to thorough mixing during the polymerization. Thorough mixing can be achieved, for example, by using special stirrers in combination with high stirring speeds, by combination of stirrers with stators and by rapid circulation, for example by means of pumping, of the reaction mixture via a bypass, it being possible for the bypass in turn to be equipped with apparatuses for generating shear forces, for example fixed internals, such as shear plates or perforated plates. Special stirrers are understood as meaning those stirrers which, in addition to a tangential flow component, also generate an axial flow field. Such stirrers are described, for example, in DE-A 197 11 022. Multistage stirrers are particularly preferred. Examples of special stirrers for generating tangential and axial flow components are crossbeam stirrers, MIGR and INTERMIGR stirrers (multistage impulse countercurrent agitators and interference multistage impulse countercurrent agitators from EKATO), axial flow turbine stirrers, it being possible for the abovementioned stirrers to be composed of one or more stages and to be combined with conventional stirrers, and furthermore helical stirrers, preferably in a design where the blades pass close to the wall, coaxial stirrers which comprise an anchor-like stirrer with blades passing close to the wall and a one-stage or multistage, high-speed central stirrer, and multiple-blade stirrers. The stirrer types described in DE-C1 4421949, JP-A 292002 and WO 93/22350 are furthermore suitable.

It has furthermore proven advantageous to carry out the process according to the invention in a manner such that the particle density of the polymer particles in the prepared aqueous dispersion does not fall below a value of about 5×10¹⁶ particles per kg of aqueous dispersion and in particular is in the range from 10¹⁷ to 3×10¹⁹ particles/kg of dispersion. The particle density does of course depend on the mean particle diameter of the polymer particles in the aqueous dispersion. The mean particle diameter of the polymer particles is preferably less than 300 nm and preferably in the range from 50 to 200 nm. The mean particle diameter is defined as usual as the weight average of the particle size, as determined by means of an analytical ultracentrifuge by the method of W. Scholtan and H. Lange, Kolloid-Z. und Z.-Polymere 250 (1972) pages 782 to 796 (cf. also W. Mächtle in “Analytical Ultracentrifugation in Biochemistry and Polymer Science”, S. E. Harding et al. (editors), Cambridge: Royal Society of Chemistry, 1992, pages 147-175). The ultracentrifuge measurement gives the integral mass distribution of the particle diameter of a sample. From this it is possible to determine the percentage by weight of the particles which have a diameter equal to or less than a certain size. In a similar manner, the weight average particle diameter can also be determined by dynamic and quasielastic light scattering of laser light (cf. H. Wiese in D. Distier (editor), “Wässrige Polymerdispersionen”, Wiley-VCH, Weinheim 1999, page 40 et seq. and literature cited there). Measures for adjusting the particle density and the mean particle diameter of aqueous polymer dispersions are known to a person skilled in the art, for example from N. Dezelic, J. J. Petres, G. Dezelic, Kolloid-Z, u, Z. Polymere, 1970, 242, pages 1142-1150 It can be controlled both by the amount of surface-active substances and by the use of seed polymers, i.e. seed latices, high emulsifier concentrations and/or a high concentration of seed polymer particles generally resulting in small particle diameters.

As a rule, it proves advantageous to carry out the emulsion polymerization in the presence of one or more very finely divided polymers in the form of aqueous latices (i.e. seed latices). Preferably from 0.1 to 10% by weight and in particular from 0.2 to 5% by weight of at least one seed latex (solids content of the seed latex, based on total amount of monomers) are used. The seed latex may be fed to the polymerization reaction partly or completely with the monomers. Preferably, however, the process with initially taken seed latex (initially taken seed) is carried out. As a rule, the latex has a weight average particle size of from 10 to 200 nm, preferably from 20 to 100 nm and in particular from 20 to 50 nm. Its constituting monomers are, for example, styrene, methyl methacrylate, n-butyl acrylate and mixtures thereof, it also being possible for the seed latex to comprise minor amounts of ethylenically unsaturated carboxylic acids, e.g. acrylic acid and/or methacrylic acid, and/or amides thereof, preferably less than 10% by weight, based on the total weight of the polymer particles in the seed latex, incorporated in the form of polymerized units.

With the use of a seed latex, a frequently adopted procedure is one in which the seed latex is initially taken partly or completely, preferably in an amount of at least 80%, in the polymerization vessel, and a part of the initiator/regulator, preferably in the abovementioned proportions, and, if appropriate, a part of the monomers to be polymerized, are added and are heated to the desired polymerization temperature. Of course, the introduction of the initiator/regulator and of the seed latex may also be effected in the opposite sequence. The monomers are preferably added only under polymerization conditions. Usually, the initially taken mixture also comprises water and, if appropriate, a part of the surface-active compounds, in addition to the initiator/regulator and the seed latex.

As a rule, a pH of 9 is not exceeded during the polymerization. The pH is controlled in a simple manner by adding a neutralizing agent in the course of the polymerization reaction. For example, bases, such as alkali metal hydroxide, carbonate or bicarbonate, and alkali metal phosphates or condensed phosphates, are suitable if the pH decreases during the polymerization. This is the case, for example, with the use of peroxodisulfates as polymerization initiators.

After the polymerization reaction, a postpolymerization for reducing the amount of unconverted monomers in the aqueous polymer dispersion (i.e. residual monomers) is also frequently effected. This postpolymerization is frequently also referred to as chemical deodorization. The chemical deodorization is effected, as a rule, by free radical postpolymerization, in particular under the action of redox initiator systems, as described, for example, in DE-A 44 35 423, DE-A 44 19 518, DE-A 44 35 422 and DE-A 102 41 481. The postpolymerization is preferably carried out using a redox initiator system comprising at least one organic peroxide and a reducing agent, preferably an inorganic sulfite or the salt of an α-hydroxysulfonic or hydroxysulfinic acid (hydrogen sulfite adduct with carbonyl compound). The amounts of initiator for the postpolymerization are as a rule in the range from 0.1 to 5% by weight preferably in the range from 0.2 to 3% by weight and in particular in the range from 0.3 to 2% by weight, based on the total amount of the monomer mixture M. In the case of initiator systems comprising a plurality of components, for example the redox initiator systems, the stated amounts are based on the total amount of these components. The chemical deodorization is preferably carried out at temperatures in the range from 60 to 100° C. and in particular in the range from 70 to 95° C. The amount of initiator used for the chemical deodorization can be added to the dispersion in one portion or continuously over a relatively long period at constant or variable, e.g. increasing, feed rate. The duration of the addition is as a rule then in the range from 10 minutes to 5 hours and in particular in the range from 30 minutes to 4 hours. The total duration of the chemical postpolymerization is as a rule in the range from 15 minutes to 5 hours and preferably in the range from 30 minutes to 4 hours.

The preparation of aqueous styrene/butadiene copolymer dispersions using a noncopolymerizable hydroperoxide by the process according to the invention gives aqueous polymer dispersions having a substantially lower proportion of residual monomers than the process of the prior art for the preparation of comparable dispersions. After the chemical deodorization usually carried out, it is possible to obtain dispersions whose content of volatile organic compounds is substantially below 10 000 ppm (parts per million), preferably below 3000 ppm, in particular below 2500 ppm and especially below 2000 ppm.

Of course, the content of volatile organic components can be even further reduced by known methods. This can be achieved in a manner known per se physically by distillative removal (in particular by means of steam distillation) or by stripping with an inert gas or by adsorption (cf. R. Racz, Macromol. Symp. 155, 2000, pages 171-180). Preferably, a chemical deodorization is first carried out after the polymerization reaction, and then a physical deodorization. Both measures can also be carried out simultaneously.

The aqueous styrene/butadiene polymer dispersions obtained according to the invention usually have solids contents of from 30 to 70% by weight, frequently from 40 to 60% by weight and often from 45 to 55% by weight.

The process according to the invention opens up the possibility of providing, on an industrial scale, aqueous styrene/butadiene polymer dispersions with short cycle times, small amounts of regulators and simultaneously low residual monomer contents, in particular low styrene and, if appropriate, comonomer contents.

Moreover, the aqueous styrene/butadiene polymer dispersions obtainable by the process according to the invention have no disadvantageous or troublesome odors at all, and they are therefore suitable as a component in emulsion paints, paper coating slips, barrier coatings, adhesives, sealing compounds, leather finishes, molded foam parts and backing coatings for carpeting and for modifying mortar, cement and asphalt and in particular as binders for paper coating slips.

### EXAMPLES

Analysis

The weight average particle diameters (D₅₀ value) were determined in an analytical ultracentrifuge (AUC) according to W. Mächtle, Makromolekulare Chemie 185, 1984, pages 1025 to 1039.

The mean particle diameters of the styrene/butadiene polymer particles were determined by dynamic light scattering on a 0.005 to 0.01% strength by weight aqueous dispersion at 23° C. by means of an Autosizer IIC from Malvern Instruments, UK. The cumulant z-average of the measured autocorrelation function is stated (ISO standard 13 321).

The solids contents were determined by drying a defined amount (about 5 g) of the aqueous polymer dispersion at 140° C. in a drying oven to constant weight. In each case two separate measurements were carried out. The value stated in the respective examples is the mean value of the two measured results.

The glass transition temperature was determined by the DSC method, 20 K/min, midpoint measurement, by means of a DSC apparatus DSC822 (series TA8000) from Mettler-Toledo, Germany, according to DIN 53765.

The residual monomer contents of the aqueous dispersions were determined by means of gas chromatography. The Perkin Elmer HS 40 apparatus, with column DB1 from J & W Scientific, USA, was used. The carrier gas used was nitrogen. The calibration of the measurements was effected using aqueous polymer dispersions having a known content of butadiene and styrene.

I. Preparation of the Aqueous Polymer Dispersions

Dispersion 1 (D1)

In a 2 l polymerization vessel, 300 g of demineralized water and 83 g of a 33% strength by weight aqueous polystyrene latex having a weight average particle diameter D₅₀ of 30 nm and 10% by weight of feed 2 were initially taken at room temperature (from 20 to 25° C.) under a nitrogen atmosphere and heated to 90° C. while stirring. Thereafter, beginning at the same time, feed 1 and the remaining amount of feed 2 were added to the polymerization vessel continuously via two separate feeds in the course of 3 hours at constant flow rates while maintaining the temperature.

After the end of the abovementioned feeds, the polymerization mixture was stirred for a further 30 minutes at 90° C. and then cooled to 85° C., and, beginning at the same time, a solution of 8 g of tert-butyl hydroperoxide and 80 g of demineralized water, and a solution consisting of 3.5 g of acetone, 5.7 g of sodium disulfite (Na₂S₂O₅) and 76 g of demineralized water were then added continuously via separate feeds at constant flow rates in the course of 2 hours while maintaining the temperature. Thereafter, 22 g of a 25% strength by weight aqueous solution of sodium hydroxide were added in one shot to the polymerization mixture, and the aqueous polymer dispersion was cooled to room temperature.

Feed 1:

| | |
|---|---|
| 490 g | of demineralized water |
| 9.9 g | of a 45% strength by weight aqueous solution of |
| | Dowfax ® 2A1 |
| 23.1 g | of a 15% strength by weight aqueous solution of sodium |
| | dodecylbenzenesulfonate (Lutensit ® A-LBN |
| | 50, brand of BASF AG, |
| | Germany) |
| 19.3 g | of a 70% strength by weight aqueous solution |
| | of tert-butyl hydroperoxide |
| 730 g | of styrene |
| 580 g | of butadiene |
| 41.0 g | of acrylic acid |
| 10.0 g | of a 25% strength by weight aqueous solution |
| | of sodium hydroxide |

Feed 2 consisted of a solution of 13.6 g of sodium peroxodisulfate in 230 g of demineralized water,

The solids content of the aqueous polymer dispersion obtained was 50.2% by weight, the mean particle diameter was 125 nm and the glass transition temperature was determined as 6° C. The residual styrene content was 1200 ppm and the residual butadiene content 160 ppm.

Dispersion 2 (D2)

In a 2 l polymerization vessel, 300 g of demineralized water and 83 g of a 33% strength by weight aqueous polystyrene latex having a weight average particle diameter D₅₀ of 30 nm and 10% by weight of feed 2 were initially taken at room temperature under a nitrogen atmosphere and heated to 90° C. while stirring. Thereafter, beginning at the same time, feed 1 and the remaining amount of feed 2 were added to the polymerization vessel continuously via two separate feeds in the course of 3 hours at constant flow rates while maintaining the temperature. 145 minutes after the start of feeds 1 and 2, 29 g of butadiene were added continuously to the polymerization mixture via a further feed in the course of 20 minutes at a constant flow rate.

After the end of the feeds 1 and 2, the polymerization mixture was stirred for a further 30 minutes at 90° C. and then cooled to 85° C., and, beginning at the same time, a solution of 8 g of tert-butyl hydroperoxide and 80 g of demineralized water, and a solution consisting of 3.5 g of acetone, 5.7 g of sodium disulfite and 76 g of demineralized water were then added continuously via separate feeds at constant flow rates in the course of 2 hours while maintaining the temperature. Thereafter, 22 g of a 25% strength by weight aqueous solution of sodium hydroxide were added in one shot to the polymerization mixture, and the aqueous polymer dispersion was cooled to room temperature.

Feed 1:

| | |
|---|---|
| 490 g | of demineralized water |
| 9.9 g | of a 45% strength by weight aqueous solution |
| | of Dowfax ® 2A1 |
| 23.1 g | of a 15% strength by weight aqueous solution of |
| | Lutensit ® A-LBN 50 |
| 19.3 g | of a 70% strength by weight aqueous solution of |
| | tert-butyl hydroperoxide |
| 730 g | of styrene |
| 551 g | of butadiene |
| 41.0 g | of acrylic acid |
| 10.0 g | of a 25% strength by weight aqueous solution |
| | of sodium hydroxide |

Feed 2 consisted of a solution of 13.6 g of sodium peroxodisulfate in 230 g of demineralized water.

The solids content of the aqueous polymer dispersion obtained was 50.1% by weight, the mean particle diameter was 123 nm and the glass transition temperature was determined as 6° C. The residual styrene content was 800 ppm and the residual butadiene content 120 ppm.

Comparative dispersion 1 (C1)

The preparation of comparative dispersion 1 was effected analogously to dispersion 1, except that feed 1 and the remainder of feed 2 were metered in not in the course of 3 hours but in the course of 6 hours.

The solids content of the aqueous polymer dispersion obtained was 50.0% by weight, the mean particle diameter was 127 nm and the glass transition temperature was determined as 9° C. The residual styrene content was 700 ppm and the residual butadiene content 100 ppm.

Comparative dispersion 2 (C2)

The preparation of comparative dispersion 2 was effected analogously to comparative dispersion 1, except that feed 1 comprised 28.9 g instead of 19.3 g of a 70% strength by weight aqueous solution of tert-butyl hydroperoxide.

The solids content of the aqueous polymer dispersion obtained was 50.1% by weight, the mean particle diameter was 125 nm and the glass transition temperature was determined as 5° C. The residual styrene content was 3100 ppm and the residual butadiene content 400 ppm.

Dispersion 3 (D3)

In an 18 m³ polymerization reactor, having a ratio of internal height to internal diameter of 2.1, equipped with a 4-speed MIG stirrer, having a diameter ratio of stirrer blade to reactor internal diameter of 0.85, 1700 kg of demineralized water, 100 kg of a 2% strength by weight aqueous solution of sodium ethylenediaminetetraacetate (Na-EDTA) and 498 kg of a 33% strength by weight aqueous polystyrene latex having a weight average particle diameter D₅₀ of 30 nm and 10% by weight of feed 2 were initially taken at room temperature under a nitrogen atmosphere and heated to 90° C. while stirring (35 revolutions per minute). Thereafter, beginning at the same time, feed 1 and the remaining amount of feed 2 were metered continuously into the polymerization reactor via two separate feeds in the course of 3 hours at constant flow rates while maintaining the temperature.

After the end of the abovementioned feeds, the polymerization mixture was stirred for a further 30 minutes at 90° C. and then cooled to 85° C. and, beginning at the same time, a solution of 54 kg of tert-butyl hydroperoxide and 480 kg of demineralized water and a solution consisting of 21 kg of acetone, 34.2 kg of sodium disulfite and 456 kg of demineralized water were then added continuously via separate feeds at constant flow rates in the course of 2 hours while maintaining the temperature. Thereafter, 132 kg of a 25% strength by weight aqueous solution of sodium hydroxide were added to the polymerization mixture in one shot and the aqueous polymer dispersion was cooled to room temperature.

Feed 1:

| | |
|---|---|
| 2940 kg | of demineralized water |
| 59.4 kg | of a 45% strength by weight aqueous solution |
| | of Dowfax ® 2A1 |
| 138.6 kg | of a 15% strength by weight aqueous solution |
| | of Lutensit ® A-LBN 50 |
| 115.8 kg | of a 70% strength by weight aqueous solution |
| | of tert-butyl hydroperoxide |
| 4380 kg | of styrene |
| 3480 kg | of butadiene |
| 246.0 kg | of acrylic acid |
| 60.0 kg | of a 25% strength by weight aqueous solution |
| | of sodium hydroxide |

Feed 2 consisted of a solution of 81.6 kg of sodium peroxodisulfate in 1380 kg of demineralized water.

The solids content of the aqueous polymer dispersion obtained was 50.0% by weight, the mean particle diameter was 129 nm and the glass transition temperature was determined as 6° C. The residual styrene content was 900 ppm and the residual butadiene content 220 ppm.

Dispersion, 4 (D4)

In an 18 m³ polymerization reactor, having a ratio of internal height to internal diameter of 2.1 equipped with a 4-speed MIG stirrer, having a diameter ratio of stirrer blade to reactor internal diameter of 0.85, 1700 kg of demineralized water, 100 kg of a 2% strength by weight aqueous solution of Na-EDTA and 498 kg of a 33% strength by weight aqueous polystyrene latex having a weight average particle diameter D₅₀ of 30 nm and 10% by weight of feed 2 were initially taken at room temperature under a nitrogen atmosphere and heated to 90° C. while stirring (35 revolutions per minute). Thereafter, beginning at the same time, feed 1 and the remaining amount of feed 2 were metered continuously into the polymerization reactor via two separate feeds in the course of 3 hours at constant flow rates while maintaining the temperature. 160 minutes after the star of feeds 1 and 2, 360 kg of butadiene were added continuously as feed 3 to the polymerization mixture via a further feed in the course of 30 minutes at a constant flow rate.

After the end of feed 3, the polymerization mixture was stirred for a further 30 minutes at 90° C. and then cooled to 85° C. and, beginning at the same time, a solution of 54 kg of tert-butyl hydroperoxide and 480 kg of demineralized water and a solution consisting of 21 kg of acetone, 34.2 kg of sodium disulfite and 456 kg of demineralized water were then added continuously via separate feeds at constant flow rates in the course of 2 hours while maintaining the temperature, Thereafter 132 kg of a 25% strength by weight aqueous solution of sodium hydroxide were added to the polymerization mixture in one shot and the aqueous polymer dispersion was cooled to room temperature.

Feed 1:

| | |
|---|---|
| 2940 kg | of demineralized water |
| 59.4 kg | of a 45% strength by weight aqueous solution |
| | of Dowfax ® 2A1 |
| 138.6 kg | of a 15% strength by weight aqueous solution |
| | of Lutensit ® A-LBN 50 |
| 115.8 kg | of a 70% strength by weight aqueous solution |
| | of tert-butyl hydroperoxide |
| 4380 kg | of styrene |
| 3120 kg | of butadiene |
| 246.0 kg | of acrylic acid |
| 60.0 kg | of a 25% strength by weight aqueous solution |
| | of sodium hydroxide |

Feed 2 consisted of a solution of 81.6 kg of sodium peroxodisulfate in 1380 kg of demineralized water.

The solids content of the aqueous polymer dispersion obtained was 50.2% by weight, the mean particle diameter was 123 nm and the glass transition temperature was determined as 5° C. The residual styrene content was 750 ppm and the residual butadiene content 250 ppm.

Comparative Dispersion 3 (C3)

The preparation of comparative dispersion 3 was effected analogously to dispersion 3, except that feed 1 and the remainder of feed 2 were metered in not in the course of 3 hours but in the course of 6 hours.

The solids content of the aqueous polymer dispersion obtained was 49.9% by weight, the mean particle diameter was 132 nm and the glass transition temperature was determined as 80. The residual styrene content was 600 ppm and the residual butadiene content 150 ppm.

II. Testing of Performance Characteristics

For the investigation, wood-free base paper (basis weight 70 g/m²) from Scheufelen, Germany was coated on one side with 10 g/m² of a paper coating slip (calculated as solid, consisting of

| | | |
|---|---|---|
| 70 | parts by weight | of Hydrocarb ® 90 (calcium carbonate |
| | | from Omya AG, Switzerland), |
| 30 | parts by weight | of Amazon Plus ® (kaolin from |
| | | CADAM S.A, Brazil), |
| 0.33 | part by weight | of Polysalz ® S (45% strength by weight aqueous |
| | | solution of a polyacrylic acid sodium salt from |
| | | BASF AG, Germany), |
| 20 | parts by weight | of one of the aqueous dispersions D1 to D4 |
| | | and C1 to C3, |
| 1.2 | part by weight | of Sterocoll ® FD (25% strength by |
| | | weight aqueous ethyl acrylate/acrylic acid/ |
| | | methacrylic acid dispersion from |
| | | BASF AG, Germany), |
| 0.2 | part by weight | of a 25% strength by weight aqueous solution |
| | | of sodium hydroxide and |
| 49 | parts by weight | of demineralized water, |

by means of a DT Laboratory Coater from DT Paper Science Oy Ab, Finland, at 30° C. and atmospheric pressure (stiffblade having a thickness of 0.3 mm). The paper web was dried by means of an IR drying unit and air drying (8 IR lamps of 650 watts each, throughput velocity 30 m per minute). Thereafter, the paper strips were calendered by means of the table laboratory calender K8/2 from Kleinewefers Anlagen GmbH, Germany, at room temperature. The nip pressure between the rolls was 200 kN/cm of paper width and the velocity was 10 m per minute, The process was carried out four times altogether. Depending on the aqueous polymer dispersion D1 to D4 and C1 to C3 used as a binder for the preparation of the respective paper coating slip, the papers obtained were designated as PD1, PD2, PD3, PD4, PC1, PC2 or PC3.

Determination of the dry pick resistance using the IGT proof printer (IGT dry)

Test strips measuring 33×3 cm were cut from the coated papers PD1 to PD4 and PC1 to PC3 and were stored for 15 hours in a conditioning chamber at 27° C. and a relative humidity of 50%.

The test strips were then printed at increasing speed in a printing unit (IGT printability tester AC2/AIC2) with a standard ink (printing ink 3808 from Lorilleux-Lefranc). The maximum printing speed was 200 cm/s. The ink was applied at a nip pressure of 350 N/cm.

The speed in “cm/sec” at which there are 10 pick points from the paper coating slip after the beginning of printing is stated as a measure of the dry pick resistance. The higher this printing speed at the tenth pick point, the better is the result rated. The results of the tests carried out with the various coated papers are listed in table 1.

Determination of the Wet Pick Resistance

The test strips were produced and prepared as described in the case of the testing of dry pick resistance.

The printing unit (IGT printability tester AC2/AIC2) was set up in such a way that the test strips are moistened with water before the printing process.

Printing was carried out at a constant speed of 0.6 cm/s.

Picks from the paper are visible as unprinted areas. For the determination of the wet pick resistance, the ink density is therefore determined in comparison with a solid hue in % using an ink densitometer. The higher the stated ink density, the better is the wet pick resistance. The results of the tests carried out with the various coated papers are likewise listed in table 1.

TABLE 1
List of the results

| | Dry pick resistance | Wet pick |
|---|---|---|
| Coated papers | in cm/s | resistance % |
| PD1 | 65 | 28 |
| PD2 | 64 | 29 |
| PC1 | 57 | 19 |
| PC2 | 68 | 30 |
| PD3 | 66 | 29 |
| PD4 | 66 | 30 |
| PC3 | 58 | 22 |

The results clearly show that the residual contents of styrene and butadiene of comparative dispersions C1 and C3 are below the respective contents of the corresponding dispersions D1 and D2 or D3 and D4 according to the invention. Comparative dispersion C2, on the other hand, has substantially higher residual contents of styrene and butadiene than the dispersions D1 and D2 according to the invention. Of particular importance, however, is the fact that the performance characteristics of the coated papers PC1 and PC3, which are coated with paper coating slips formulated with the comparative dispersions C1 and C3, respectively are substantially poorer in comparison with the coated papers PD1 and PD2 or PD3 and PD4, which are coated with paper coating slips formulated with the dispersions D1 and D2 or D3 and D4.

By increasing the amount of regulator in the preparation of comparative dispersion 2, it was possible to produce a coated paper PC2 whose performance characteristics are comparable with the properties of the papers PD1 and PD2 according to the invention but the comparative dispersion 2 obtained has substantially higher residual monomer contents in comparison with the dispersions 1 and 2 according to the invention as well as with comparative dispersion 1.

1. A process for the preparation of an aqueous styrene butadiene polymer dispersion by free radical aqueous emulsion polymerization of a monomer mixture M comprising
from 30 to 80% by weight of styrene,
from 20 to 70% by weight of butadiene and
from 0 to 40% b weight of at least one ethylenically unsaturated comonomer differing from styrene and butadiene,
based in each case on the total amount of the monomer mixture M, by a monomer feed process in the presence of a noncopolymerizable hydroperoxide of the general formula R—O—O—H as a regulator, where R may be hydrogen, C₁-C₁₈-alkyl, C₇-C₂₂-aralkyl or a saturated or unsaturated carbocyclic or heterocyclic ring having 3 to 18 carbon atoms, wherein the monomer mixture M is fed to the polymerization vessel in the course of 4 hours.

2. The process according to claim 1, wherein the total amount of butadiene is ≧1000 kg.

3. The process according to claim 1, wherein the total amount of butadiene is ≧5000 kg.

4. The process according to claim 1, wherein the monomer mixture M is fed to the polymerization vessel in the course of 3.5 hours.

5. The process according to claim 1, wherein the monomer mixture M is fed to the polymerization vessel in the course of 3 hours.

6. The process according to claim 1, wherein ≦30 by weight of the hydroperoxide are initially taken in the polymerization vessel before the beginning of the polymerization reaction and the residual amount thereof is fed to the polymerization vessel in be course of the polymerization reaction.

7. The process according to claim 1, wherein the polymerization reaction is carried out in the presence of at least one seed latex.

8. The process according to claim 1, wherein the radical R is hydrogen, tert-butyl, tert-pentyl, 1,1-dimethylbutyl or 1,1-dimethylpentyl, wherein said organic radicals may also be optionally substituted by a hydroxyl group.

9. The process according to claim 1, wherein the regulator used is at least one hydroperoxide which is selected from the group consisting of a hydrogen peroxide, tert-butyl hydroperoxide, cumyl hydroperoxide, diisopropylbenzene monohydroperoxide, tert-pentyl hydroperoxide, 1,1-dimethylbutyl hydroperoxide, 1,1-dimethylpropyl hydroperoxide, 1,1-dimethyl-3-hydroxybutyl hydroperoxide, 1,1,3,3-tetramethylbutyl hydroperoxide, p-menthyl hydroperoxide, pinanyl hydroperoxide, 1-methylcyclopentyl hydroperoxide, 2-hydroperoxy-2-methyltetrahydrofuran, 1-methoxycyclohexyl hydroperoxide, 1,3,4,5,6,7-hexahydro-4a(2H)-naphthalenyl hydroperoxide, β-pinene hydroperoxide and 2,5-dihydro-2-methyl-2-furanyl hydroperoxide.

10. The process according to claim 1, wherein the hydroperoxide is used only as a regulator and in combination with an initiator the molar ratio of hydroperoxide to the initiator being from 0.2 to 1.

11. The process according to claim 1, wherein the hydroperoxide is used simultaneously as regulator and initiator without a further free radical initiator being used.

12. The process according to claim 11, wherein a reducing agent is used in addition to the hydroperoxide,

13. The process according to claim 12, wherein the molar ratio of hydroperoxide to reducing agent is from 1.2 to 20.

14. The process according to claim 1, wherein the monomer mixture M is fed to the polymerization vessel in the form of the monomer feeds Mz1 and Mz2, the feed Mz1 comprising styrene, butadiene and, if appropriate at least one comonomer and the feed Mz2 consisting exclusively of butadiene, feed Mz2 being fed in when ≧70% by weight of feed Mz1 have been fed to the polymerization vessel, for a period Tz2 of ≧1% of the total feed time Tz1 of the feed Mz1, and feed Mz2 consisting of ≦3% by weight of the total amount of butadiene.

15. The process according to claim 14, wherein
a) feed Mz2 is begun when ≧80% by weight of feed Mz1 have been fed to the polymerization vessel,
b) the period Tz2 is from ≧5 to ≦40% of the total feed time Tz1 of feed Mz1, and
c) feed Mz2 consists of from ≧0.5 to ≦30% by weight of the total amount of butadiene.

16. The process according to claim 14, wherein feed Mz1 is ended after feed Mz2.

17. An aqueous styrene/butadiene polymer dispersion obtainable by a process according to claim 1.

18. The use of an aqueous styrene/butadiene polymer dispersion according to claim 17 as a component in emulsion paints, paper coating slips, barrier coatings, adhesives, sealing compounds, leather finishes, molded foam parts and backing coatings for carpeting and for modifying mortar, cement and asphalt.
